(19) United States
(12) Patent Application Publication
(10) Pub. No.: US 2008/0220219 A1
(43) Pub. Date: Sep. 11, 2008

(54) Combination Floor Drawing Mats

(76) Inventor: Jim LAI, Industry, CA (US)

Correspondence Address: LAW OFFICES OF J.F. LEE, 17800 CASTLETON STREET, SUITE 383, CITY OF INDUSTRY, CA, 91748, US

(21) Appl. No.: 11/683,852

(22) Filed: Mar. 8, 2007

(51) Int. Cl. B32B 5/18; B32B 7/06

(52) U.S. Cl. 428/192; 428/98

(57) ABSTRACT

A combination floor drawing mat is made up from individual foam pieces that can be inter-connected with one another. Each piece is made up basic geometric shape, such as square, triangle, or pentagon. With the layer of lamination affixed to one side of said foam pieces, children and do all their imaginative and creative drawing on the floor and parents can clean up easily. Each piece contains jagged edges that allow tight fitting. When an outside strip containing a raised ridged is used, said floor drawing mat is defined in a way as desired by consumers, and the pens, crayons or other drawing instruments will be easy to be collected and put away, due to the “walled in” by said ridges, that also help to contain any spilled liquids that oftentimes accompany children's play activities.

### FIELD AND BACKGROUND OF PRESENT INVENTION

Drawing boards for children are available in many stores. However, drawing board or mats on the floor, with ease of setup and freedom of defining the allowed area of drawing, has never been made available.

### OBJECT AND SUMMARY OF THE PRESENT INVENTION

A main object of the present invention is to provide flexible floor drawing mats for children that can be made a combination of different basic geometric modules, allowing children to express their creative talents on the floor.

Another object of the present invention is to provide a safe play area, while children can doodle on it and even allowing adults to have education interaction with children on the combination floor drawing mats with children.

Accordingly, in order to accomplish the above objects, the present invention provides a combination floor drawing mats comprising a plurality of foam pieces that contain jagged edges that can be fitted to one another.

Each foam piece has a layer of lamination coating that allows all kinds of drawing instruments, color pen, crayons, for example, to be drawn on, while easy for adults to clean up.

Additionally, some numbers of foam strips are provided, each has a raised edge along the length, so that when these strips are set to confine the outer perimeter of said combination floor drawing mat, a well defined and “welled” area is present, easy to collect children's play things and drawings instruments.

### BRIEF DESCRIPTION OF THE DRAWINGS

FIG. 1 is a perspective view of a first foam piece layer, having jagged edges on all sides.

FIG. 2 is a perspective view of a lamination layer, matching the shape of said first foam layer, hovering on top of first foam piece.

FIG. 3 is a perspective view of a foam strip.

FIG. 4 shows side view of a foam strip, containing a ridge along the length of said foam strip.

### DETAILED DESCRIPTION OF THE EMBODIMENT

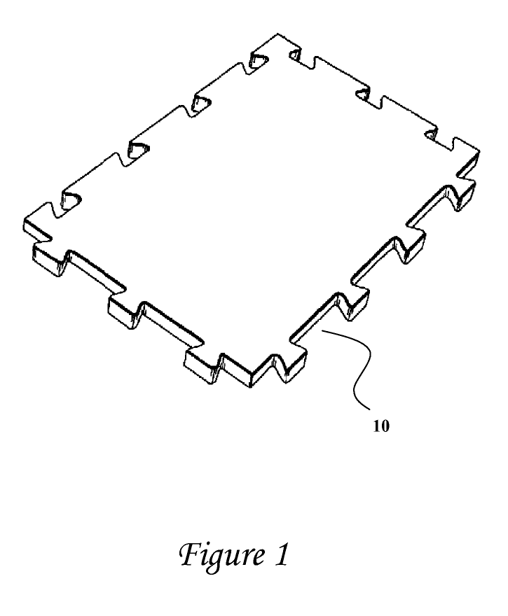

Referring to FIG. 1, a first foam piece 10 is shown, as the basic building block of the floor combination drawing mats. Jagged edges are made to all sides. Present invention does not claim the specific shapes of these jagged edges; nor are these jagged edges form the claimed part of present invention, except to the extent they are claimed along with other necessary elements of present invention, forming the inventive substance herein.

The foam material can be any type of flexible material commonly found on toys available in the market and requires no disclosure in present invention and is not part of the claimed invention, except to the extent it is used with other claimed elements.

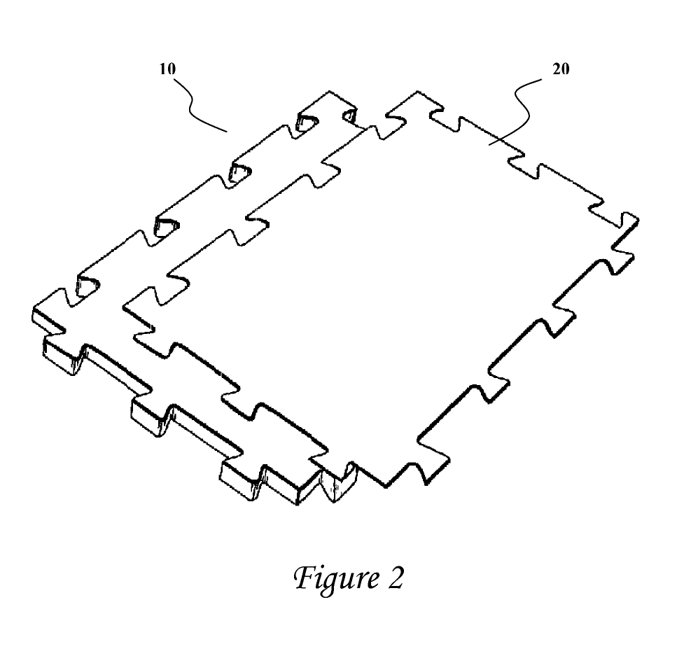

FIG. 2 shows the lamination layer 20 that can be fixed on top of said foam piece 10, creating a surface suitable for drawing and easy for clean up, on the floor.

Lamination layer 20 can be fixed to foam piece 20 by means generally known in the industry, such as standard glue, heat press, or any other means. Said means of attaching lamination layer 20 to foam piece 10 are known in the industry and require no disclosure herein. Said means are not part of the claimed invention, except to the extent it is claimed with other necessary elements of present invention.

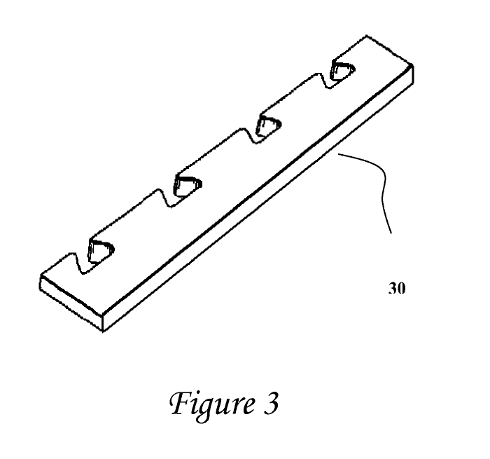

FIG. 3 shows a foam strip 30, which can be used to set the outer perimeter of a combination floor drawing board, as parents or users desire to be after fitting a numbers of foam pieces 10 (containing lamination layer 20) together.

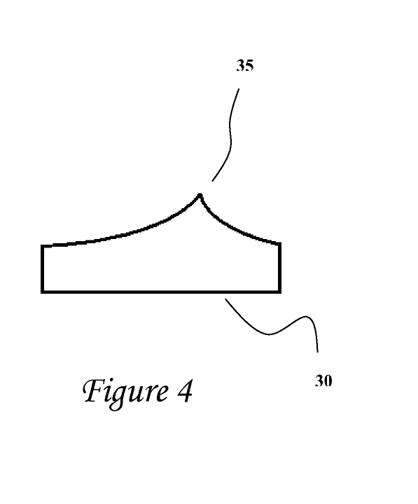

A raised ridge 35 is shown on FIG. 4, which helps to define a connected wall around the combination floor drawing mats, as put together by inter-connecting the foam pieces. Such drawing mats on the floor, in accordance with the disclosure of present invention, can be made into any shapes that people desire. With the strip foam pieces 30, and the raised ridges 35 along the length of said foam strips 30, children's crayons, water color pens and various toys are collected within the walled-in area, making cleaning up a much more easier task for parents or adults.

FIG. 4 shows a raised ridge 35 on the foam strip 30, when viewed from the side.

Foam material used in present invention provides a cushioning and safe area that children can engage in some amount of horseplay, which is typical of children's behavior even during drawing or other creative activities.

The foam pieces 10, along with the lamination layer 20, when inter-connected, generally form a pretty tight flat piece, due to the inherent resilience of the foam material. With the foam strips 30 and the ridge 35, the floor drawing mats also helps to contain spilled liquids that are oftentimes the result of children's playing activities.

What is claimed is:

1. Combination floor drawing mats, comprising:
A plurality of first layer pieces of foam material, each forming a basic geometric shape and having jagged edges for inter-connecting with other pieces;
A second layer of thin lamination material affixed to one side of said foam material of first layer piece; and,
Means for affixing said lamination material to said foam layer piece.

2. The combination floor drawing mats of claim 1, further comprising:
A plurality of foam strips made from resiliently deformable material, each having smooth edges on one side and jagged edges on the other side, that can be fitted to said jagged edges of said first layer pieces, for defining the outer perimeter of drawing mats on the floor.

3. The combination floor drawing mats of claim 2, wherein said foam strips are color-coded to be different from the color as shown by the lamination.

4. The combination floor drawing mats of claim 2, wherein said foam strips' surface are made to have ridge along the length of said strips, so that when said foam strips are inter-connected with said first layer pieces into a floor drawing mats, a raised ridge is formed along the outer perimeter of said drawing mats.
